(19) United States
(12) Patent Application Publication
(10) Pub. No.: US 2007/0066139 A1
(43) Pub. Date: Mar. 22, 2007

(54) Electronic plug unit

(76) Inventors: Heiko Roeper, Radeberg (DE); Johannes Hankofer, Aiterhofen (DE); Armin Kohlhase, Neubiberg (DE); Elard Stein Von Kamienski, Dresden (DE); Harry Hedler, Germering (DE)

Correspondence Address: SLATER & MATSIL LLP, 17950 PRESTON ROAD, SUITE 1000, DALLAS, TX, 75252, US

(21) Appl. No.: 11/513,504

(22) Filed: Aug. 31, 2006

(30) Foreign Application Priority Data
Aug. 31, 2005 (DE) 10 2005 041 451.6

(51) Int. Cl. H01R 13/648

(52) U.S. Cl. 439/607

(57) ABSTRACT

An electronic device includes a first semiconductor device and a second semiconductor device mounted over the first semiconductor device. An encapsulation material surrounds the first and second semiconductor devices so that the first and second semiconductor devices are embedded within a molded package. A plug connector extends from the molded package and is electrically coupled to at least one of the first and second semiconductor devices.

This application claims priority to German Patent Application 10 2005 041 451.6 which was filed Aug. 31, 2005 and is incorporated herein by reference.

### TECHNICAL FIELD

The invention relates to an electronic plug unit having a standard or de-facto standard interface, for example a USB stick with a USB plug-type connector which is electrically connected to active and/or passive electronic components within a housing, for example to a flash memory and associated controller.

### BACKGROUND

USB (universal serial bus) sticks, for example USB memory sticks, USB-TPM sticks, USB-WLAN sticks or other USB adapters, are composed, inter alia, of a laminated substrate (board) to which components are attached by soldering or bonding. The board is provided with copper conductor tracks for forming electrical contact between chips and/or components and the external terminals, and for connecting them to one another.

Circuit components for a USB memory stick are illustrated in International Patent Application No. WO 0161692 A1, which is incorporated herein by reference. These include, for example, a flash memory, additional RAM or ROM areas, a controller, driver modules, a USB plug-type connector and a switch.

One embodiment of USB plug-type connectors is described in U.S. Patent Publication No. 2002/0086581 A1, which is incorporated herein by reference. The plug-type connector is composed of a plurality of contact pins that are embedded into a plastic mount and are surrounded by a shield. Pins and a shield are provided with contacts for connection to a board.

The housing of USB memory sticks is usually formed using plastic frames (housing half shells), between which the board is inserted with the completely mounted parts. The shape of the plastic frames at the same time secures the board and plug in the housing. The mechanical connection of the frames to one another is provided by roll seam welding or ultrasonic welding, bonding or lashing by means of known snap-in connections.

The effort required in mounting such USB sticks is very high due to the large number of mounting steps and of individual parts so that the price of a USB stick is influenced to a considerable extent by the mounting costs and parts costs.

A particular embodiment for mobile data memories provides for the housing to be manufactured by encapsulation with a plastic by molding or injection molding.

Such an arrangement is disclosed in German Patent No. 196 24 631 C2, which is incorporated herein by reference. In this card arrangement, an outwardly leading plug-type connector is provided, which is connected to a circuit arrangement (one or more chips and, if appropriate, further components) within a housing, the housing being composed, if necessary, of a sealing compound that encapsulates the circuit arrangement. The plug-type connector may be embodied here as part of a metallic carrier strip (lead frame), which serves to mechanically attach and form electrical contact for the chip and further circuit components and is connected to the chip using bonding wires, for example. Alternatively, the semiconductor chip is surrounded by the housing without a carrier strip and is connected directly to the correspondingly shaped plug-type connector by means of wire bonding or contact bumps.

U.S. Patent Publication No. 2002/0140068 A1, which is incorporated herein by reference, discloses a semiconductor package that is based on a lead frame, a chip or a stack of two chips being mounted on strips of the lead frame and being electrically connected to it by means of wire bridges. The entire arrangement is encapsulated with a molding material, only necessary external contact faces being exposed.

Furthermore, European Patent No. 1 111 540 A1, which is incorporated herein by reference, describes a method for manufacturing a plastic object, in particular a multimedia card. A printed circuit board, which is equipped with a semiconductor chip, is arranged in the cavity in an injection mold that is composed of mold halves, the semiconductor chip being bare and unprotected. The semiconductor chip or a lead frame has, on the side facing the lower mold half, electrical external contacts for the finished plastic object. In order to secure the initial parts, fixed or retractable pins may be arranged in the upper mold half. This ensures that molding material cannot reach the external contacts during the molding process.

### SUMMARY OF THE INVENTION

In one aspect, the invention provides, in a further development of the aforesaid packaging technologies, an electronic plug unit having a standard or de-facto standard interface, for example a USB stick with a USB plug-type connector, which plug unit can be manufactured particularly cost-effectively and efficiently and permits a high degree of integration density of the circuit used.

This is achieved in an electronic plug unit of the type mentioned at the beginning in that plug-type connectors with contact pins and a shield, board, housing and circuit components are replaced by a molded package, at least partially forming the housing of the electronic plug unit, with a plug-type connector whose outer terminal is embodied in the form of a shield and/or contact pins and which serves as a carrier and/or for making electrical contact with an integrated active electronic circuit structure that is at least partially separated from a semiconductor chip, a plurality of semiconductor chips that are mounted one on the other as a second level assembly, a circuit structure on a film basis or fabric basis and/or on the basis of other inorganic, organic or combined materials with embedded circuit structures, printed circuit structures or with circuit structures that are applied and/or introduced using other methods, forming a level 1, and is provided with single-layer and/or multilayer redistribution lines, a redistribution layer or layers and/or further conductor tracks and surfaces for wiring (referred to below as RDL) at this level 1, and to which one or more additional chips, active and/or passive components, assemblies or parts thereof, forming a further level (level 2) or a plurality of levels 2 . . . n, are connected and/or placed in contact, are replaced.

In a further embodiment of the invention, the plug-type connector is formed in the interior of the electronic plug unit as a lead frame that is provided with one or more pads for mounting and making contact with the integrated active electronic circuit structure as well as further components.

The manufacture of the plug-type connector with contact pins and a shield and lead frame as well as pads including the cutouts and spring elements in the shield can be manufactured, for example, by punching or etching.

The shield of the plug-type connector is composed here of a multiply bent section of the initial material. The plastic mount in the interior of the plug-type connector can be fabricated in one operation when the entire plug unit is molded.

Contact pins, the shield and the pad or pads as well as, if appropriate, further components of the lead frame can be provided with the packaging with rounded edges, down sets and/or with coatings (for example Au, Ag, Cr, Sn) before the mounting of the active and/or passive circuit components.

One development of the invention is defined by the fact that a chip stack arrangement whose chips are electrically connected to one another by means of, for example, Au wire bridges, bumps, redistribution lines or layers and/or by means of conductive plastic is mounted on at least one pad.

In a further development of the invention, additional active and/or passive circuit components are mounted on the lead frame directly and/or by means of interposers on a PCB base, ceramic base or silicon base and/or are electrically connected to the plug-type connector or to the lead frame.

In one embodiment of the invention, the integrated active electronic circuit structure is provided with an RDL on the rear side and/or on the front side and rear side, and/or is equipped on one side or on two sides with additional chips, active and/or passive components, assemblies or parts thereof. The electrical connection of the front side and rear side is carried out by means of, for example, vias, RDLs routed around the edges and/or by means of the lead frame or plug-type connector.

In a further embodiment of the invention, the integrated active electronic circuit structure and, if appropriate, additional active and/or passive components of the electronic plug unit are mechanically and/or electrically connected to the plug-type connector or lead frame by means of chip bonding, wire bonding, flip-chip methods or bonding.

In a method for fabricating the electronic plug unit, the integrated active electronic circuit structure and, if appropriate, further active and/or passive components are partially molded with a molding material. In one of the following fabrication steps, one or more RDLs are manufactured on the front or rear side of the active electronic circuit structure and/or of the optionally planarized molding material. The mounting of further levels of active and/or passive components and a subsequent molding process or the application of a protective layer or cover can be carried out subsequently.

In one embodiment of the fabrication method, additional active and/or passive components or components and/or circuit structures made using thin or thick film technology are arranged under, on and/or within the RDL, the molding material or on the electronic circuit structure.

The invention will be explained in more detail below using an exemplary embodiment.

### BRIEF DESCRIPTION OF THE DRAWINGS

In the associated figures in the drawing:

FIG. 1 is a schematic illustration of an electronic plug unit according to the invention with a USB interface, a chip stack arrangement and a SMD component with a housing which encapsulates the circuit arrangement;

FIG. 2 is a variant according to FIG. 1 with stacked chip-on-chip mounting on a metal lead frame as well as additional SMD components, in which the parts of the USB plug connector and lead frame are mechanically connected to adjacent parts by means of metal strips (tie bars);

FIG. 3 is a side view of a triple chip stack with an additional redistribution layer of flash memory as well as wire bridges for making electrical contact between the components and with the metal lead frame;

FIG. 4 is a schematic plan view of a plug-type connector/lead frame according to the invention without a shield and with a memory chip that is mounted on a die pad, with an additional RDL for making contact with a further chip and of SMD components before they are placed in a mold housing;

FIG. 5 shows an arrangement that is comparable to FIG. 4 and has a shield and an additionally mounted PCB;

FIG. 6 is a schematic plan view of a plug-type connector according to the invention with an additional SME component that is connected by means of RDL, and additional SMD components and a PCB interposer for further components;

FIG. 7 is a strip section with multiple arrangement of USB lead frame segments;

FIG. 8 shows the strip section according to FIG. 6 with USB sticks that are provided with a housing by molding;

FIG. 9 shows a longitudinal section through a USB stick according to the invention;

FIG. 10 shows a longitudinal section through an embodiment variant of a USB stick according to the invention; and

FIG. 11 shows a longitudinal section through a further embodiment variant of a USB stick according to the invention.

The following list of reference symbols can be used in conjunction with the figures:

| | |
|---|---|
| 1 | Shield |
| 2 | Contact pin |
| 3 | Chip |
| 4 | Chip |
| 5 | SMD component |
| 6 | Die pad |
| 7 | Lead frame |
| 8 | Housing |
| 9 | Die attach |
| 10 | Wire bridge |
| 11 | Bonding contact |
| 12 | Contact |
| 13 | Flash memory |
| 14 | Controller |
| 15 | Contour line |
| 16 | Metal strip |
| 17 | Connecting strip |
| 18 | Anchor |
| 19 | SMD contact pad |
| 20 | Si spacer |
| 21 | RDL layer |
| 22 | Printed circuit board (PCB) |
| 23 | Cutout |
| 24 | Si substrate |
| 25 | Interposer |
| 26 | Microball |
| 27 | CSP component |
| 28 | RDL layer |
| 29 | Sealing compound |
| 30 | Protective layer |

### DETAILED DESCRIPTION OF ILLUSTRATIVE EMBODIMENTS

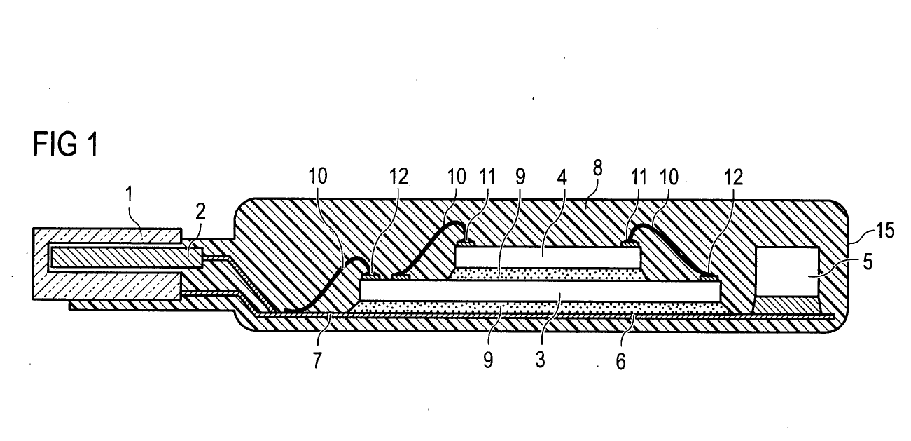

FIG. 1 is a schematic illustration of a semiconductor arrangement with a USB interface, composed of a shield 1 and contact pins 2 as well as an arrangement of stacked chips 3, 4 and an SMD (surface mount device) component 5 on a die pad 6 of a lead frame 7 with a housing 8 made of a molding material. The molding material encapsulates the lead frame 7 here with the components arranged thereon, as well as parts of the USB plug-type connector. The chips 3, 4 are mounted on the die pad 6 or on one another by means of a die attach material 9 (bonding film or the like). Wire bridges 10, for example made of gold wire, are provided for electrically connecting the chips 3, 4 to one another and to the lead frame 7.

The wire bridges 10 are drawn between bonding contacts 11 on the upper chip 4 and contacts 12 of a redistribution layer (rewiring) on the lower chip 3 and between the contacts 12 of the lower chip 3 and elements of the lead frame 7.

The molding material assumes here at least partially the function of the housing 8 and serves simultaneously to protect against electrical and mechanical effects and is used for providing labeling and for handling the entire arrangement. The molding material is pressed during the molding process in one fabrication step over the completely finished circuit arrangement and parts of the plug-type connector (shield 1, contact pins 2) so that a uniform molded element is produced and additional packaging fabrication steps can be dispensed with.

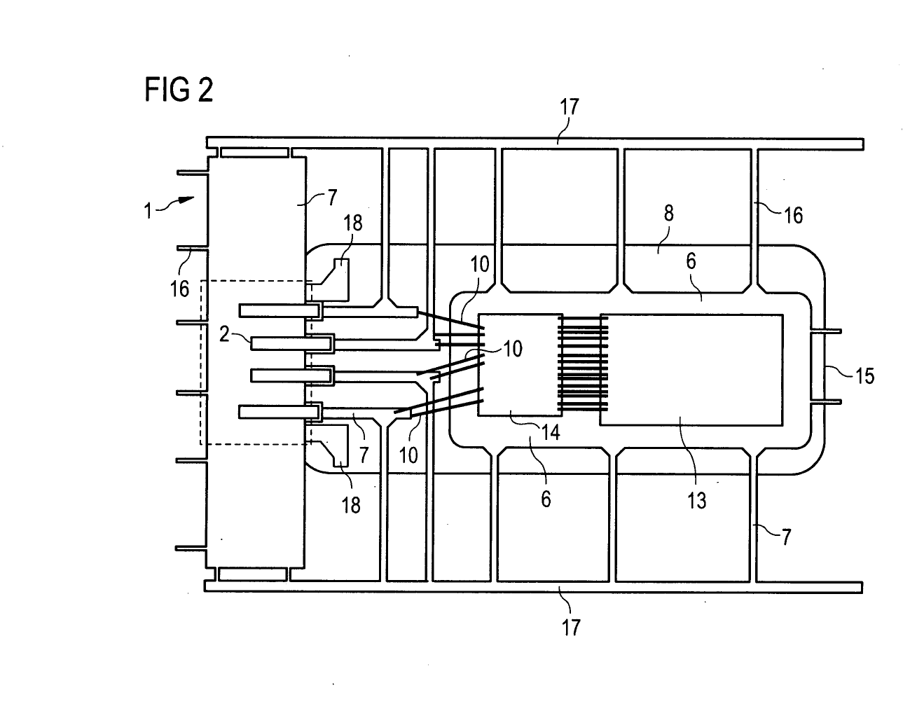

FIG. 2 is a schematic view of a variant according to FIG. 1 with stacked chip-on-chip mounting on a metal lead frame 7 in which the parts of the lead frame 7 and of the shield 1 of the USB plug are mechanically connected to adjacent parts of the lead frame 7 by means of metal strips 16 (tie bars) and to one another by means of connecting strips 17.

A flash memory 13 and a controller 14 are mounted on a die pad 6 and are connected to one another and to the lead frame 7 by means of wire bridges 10.

The housing 8 is also manufactured here by encapsulation with a molding material within the contour line 15 after the shield 1 has been appropriately bent.

Furthermore, an anchor 18 for anchoring in the housing 8 is located on the shield 1.

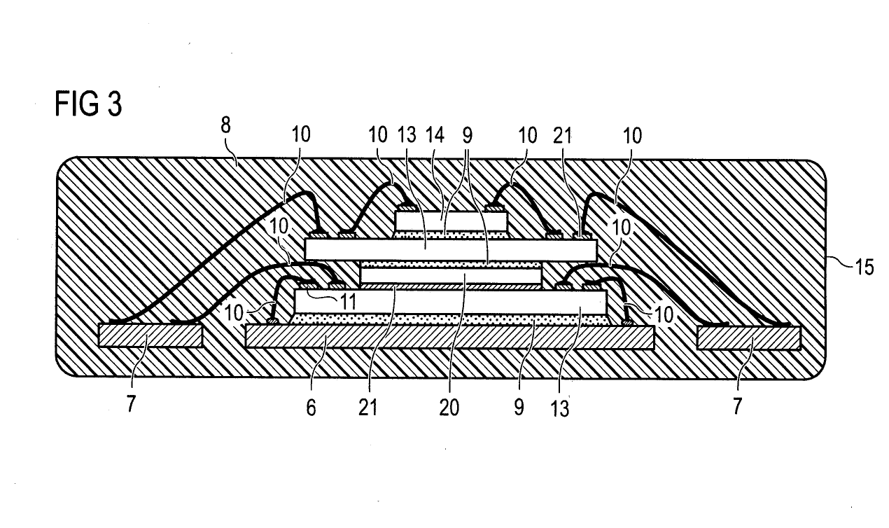

FIG. 3 is a schematic sectional illustration of a triple chip stack made of flash memories 13 with an associated controller 14 and with an additional redistribution layer 21 on the flash memories 13 as well as wire bridges 10 for making electrical contact between the components and with the metal lead frame. The flash memories 13 are attached to the die pad 6 and to one another by means of a die attach 9 (bonding agent or film) with the intermediate positioning of a Si spacer 20.

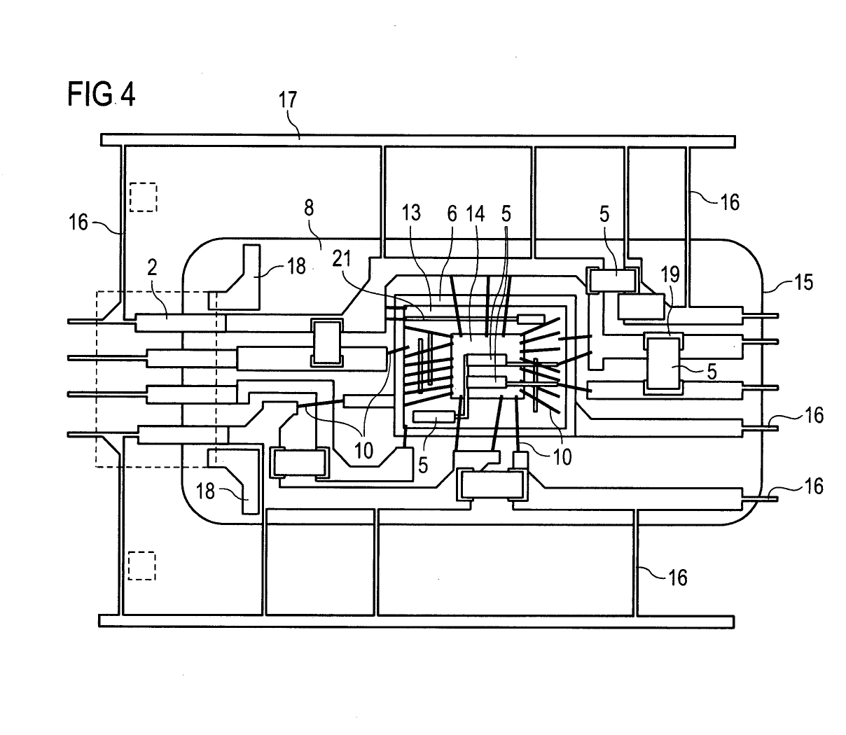

FIG. 4 shows an example of chip-on-chip mounting of a semiconductor arrangement with a USB interface without a shield, the arrangement being provided with an additional RDL 21. This additional RDL 21 is used for forming contact with SMD components 5 directly on the upper chip 4.

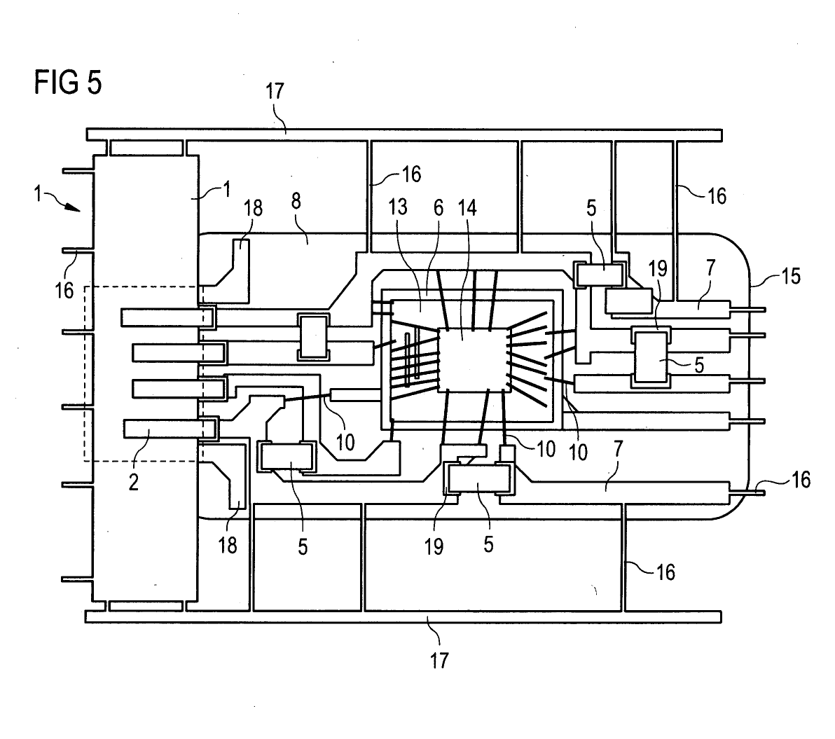

FIG. 5 shows chip-on-chip mounting of a semiconductor arrangement with a USB interface corresponding to FIG. 4 with a shield 1.

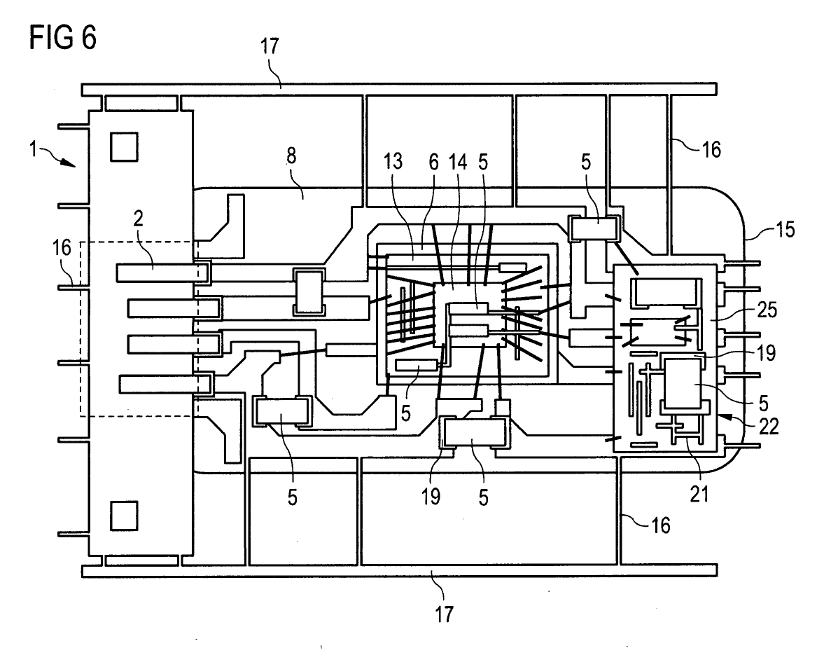

FIG. 6 shows a schematic plan view of a plug-type connector according to the invention, similar to FIG. 5, with a flash memory 13 and additional SMD components 5 that are connected by means of RDLs as well as additional SMD components and a PCB interposer 25 for further components with SMD contact pads 19.

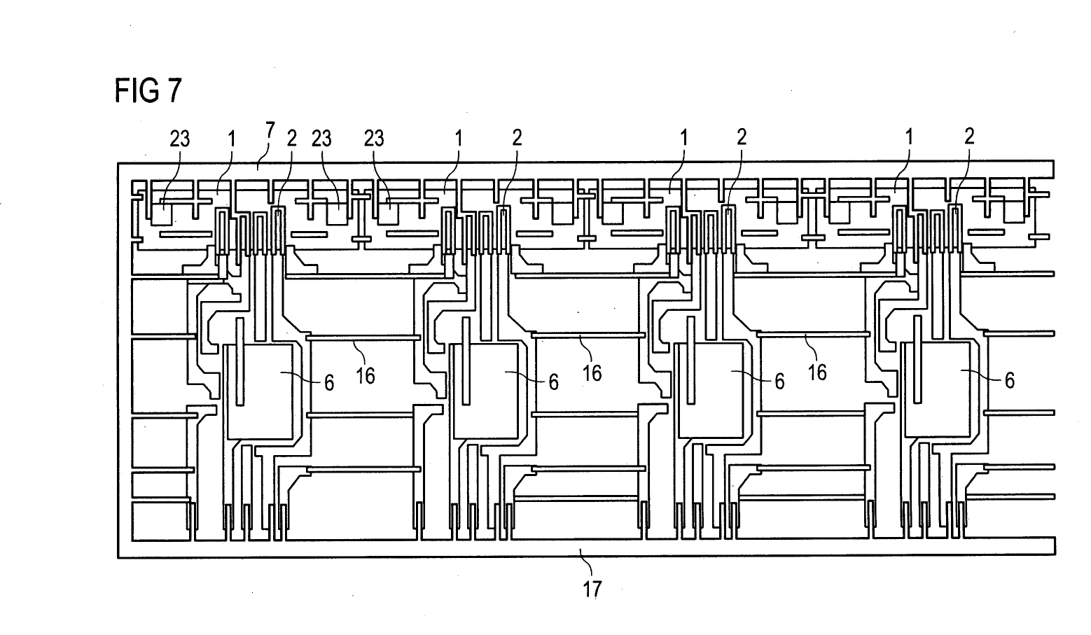

The previous figures in the drawing each show individual USB interfaces, i.e., a detail of a lead frame. FIG. 7 then shows a multiple arrangement of individual USB interfaces one next to the other. The shield 1 is provided here in each case with cutouts 23, which serve to hold spring elements of a USB socket.

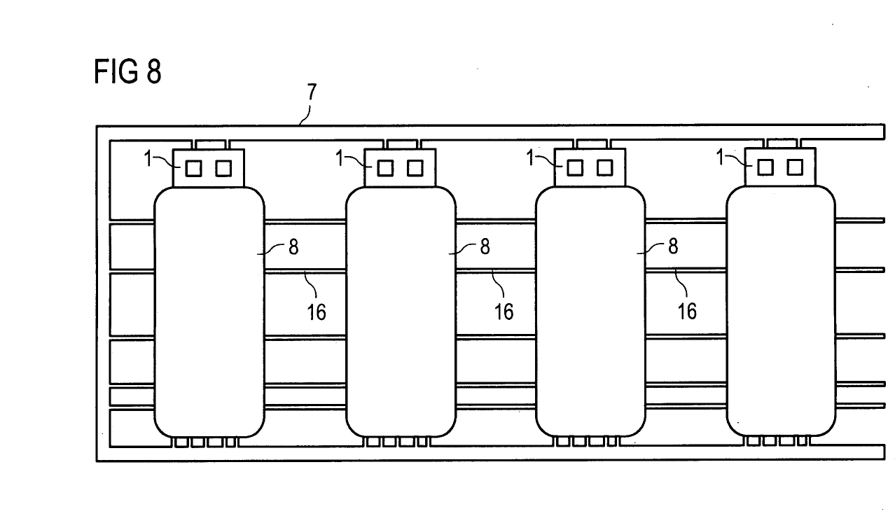

FIG. 8 shows the arrangement according to FIG. 7 in which the individual interfaces are each provided with a housing 8, but are still connected to one another by means of the lead frame 7. The separation is then carried out by cutting the metal strips 16 and the connecting strips 17, which is carried out directly on the respective housing 8 in each case.

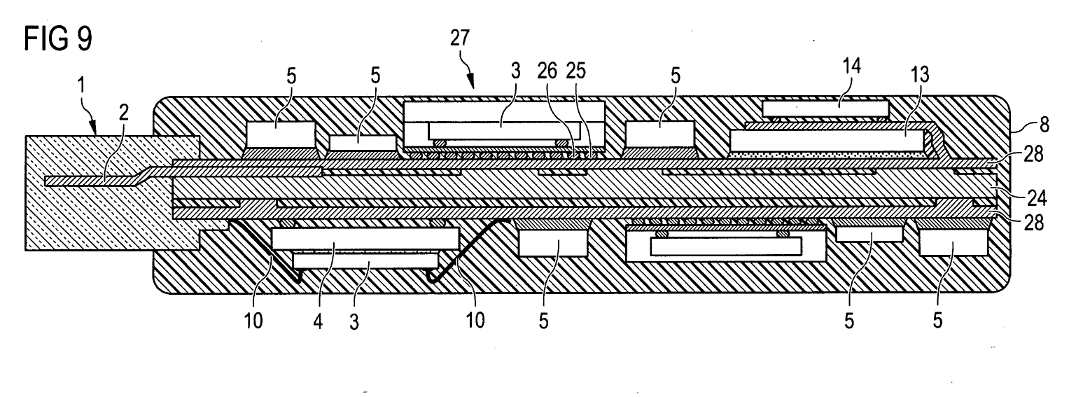

FIG. 9 illustrates a completely molded USB stick, which is provided with a housing 8 and is constructed on an active Si substrate 24. The contact pins 2 are connected electrically and mechanically to the Si substrate 24. The shield 1 is permanently anchored in the housing 8. On each side of the Si substrate 24 there is a redistribution layer 28 for making electrical contact with SMD components 5, chips 3, 4 in a stack arrangement and CSP (chip scale package) components 27 that are connected electrically and mechanically to the redistribution layer 28 by means of microballs or solder balls 26. On the other side of the Si substrate 24 there is a further RDL layer 28 on which SMD components 5, a chip 3, and on the chip 3 a CSP component 27 as well as a flash memory 13 with associated controller 14 are mounted.

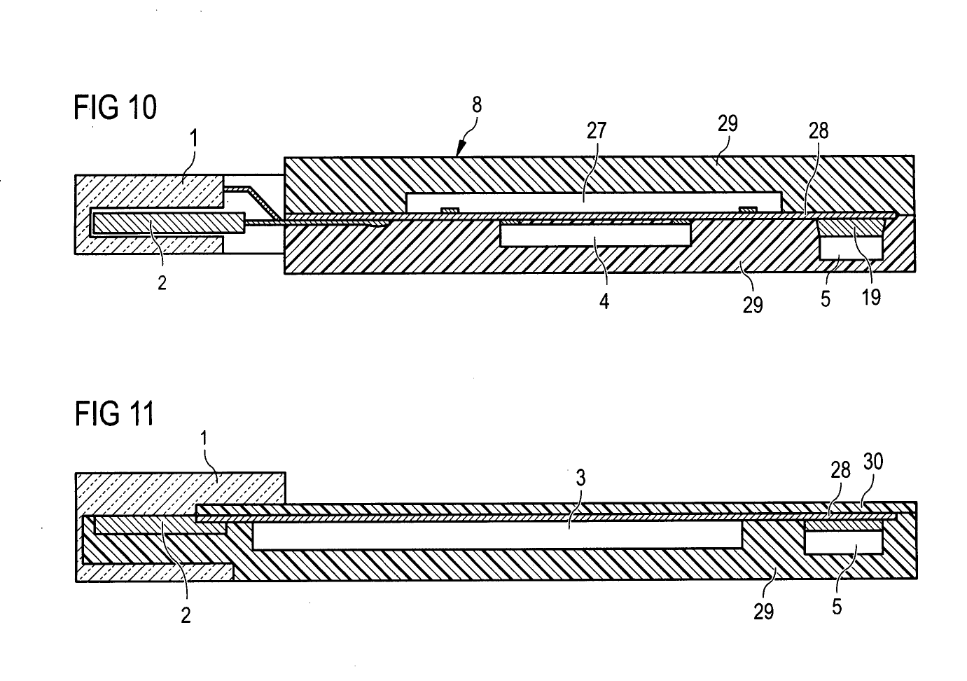

FIG. 10 shows a specific embodiment of a USB stick with a shield 1 and contact pins 2 in a housing 8 in which chips have been provided with a sealing compound 29 before the molding of the housing 8. In addition, SMD components 5, which have been attached by means of SMD contact pads 19 on a RDL layer 28 provided on one side of the Si substrate 24, are embedded in the housing 8.

The RDL layers 28 can be applied here directly on the active electronic circuit structure of the Si substrate 24 and/or on the optionally planarized molding material. Active and/or passive components are then mounted (as mentioned above) and a subsequent molding process takes place.

A further specific embodiment of the invention is illustrated in FIG. 11. Here, a CSP component 27 and, if appropriate, further components such as an SMD component 5, have been mounted on an RDL layer 28 and encapsulated with a sealing compound 29. Finally, the redistribution layer 28 has been provided with a protective layer 30 and the shield 1 has been mounted.

FIG. 11 shows a similar embodiment in which a chip 3 and an SMD component 5 are mounted on an RDL layer 28, the chip side being covered with a sealing compound 29 and the RDL layer 28 with a protective layer 30.

What is claimed is:

1. An electronic device comprising:
a first semiconductor device;
a second semiconductor device mounted over the first semiconductor device;
an encapsulation material surrounding the first and second semiconductor devices so that the first and second semiconductor devices are embedded within a molded package;
a plug connector extending from the molded package, the plug connector being electrically coupled to at least one of the first and second semiconductor devices, the plug connector including a shield and a contact pin.

2. The electronic device of claim 1, further comprising an electronic component embedded within the molded package.

3. The electronic device of claim 2, further comprising a carrier structure that is integral with at least a portion of the plug connector, the electronic component being electrically coupled to the carrier structure.

4. The electronic device of claim 1, wherein the first semiconductor device is mounted on a circuit board, the electronic device further comprising one or more additional chips, active components and/or passive components mounted on the circuit board.

5. The electronic device of claim 1, wherein the plug connector comprises a USB interface.

6. The electronic device of claim 4, wherein the active and/or passive components includes a flash memory and a flash memory controller.

7. The electronic device of claim 1, wherein the plug connector is a part of a lead frame that includes one or more pads for mounting and making contact with electronic components.

8. The electronic device of claim 1, wherein the first semiconductor device is electrically coupled to the second semiconductor device by wire bridges.

9. The electronic device of claim 1, further comprising a lead frame within the encapsulation material, the lead frame being electrically coupled to the first semiconductor device and at least one other electronic component.

10. The electronic device of claim 9, wherein the lead frame is also electrically coupled to the plug connector.

11. The electronic device of claim 1, wherein the first semiconductor device includes a redistribution layer on a rear side and on a front side.

12. The electronic device of claim 11, wherein the front side and rear side are electrically coupled to one another by means of vias, conductive lines routed around edges of the first semiconductor device and/or a lead frame.

13. The electronic device of claim 1, further comprising additional active and/or passive components that are mechanically and/or electrically connected to the plug connector by means of chip bonding, wire bonding, flip-chip methods or bonding.

14. An electronic plug unit comprising:
a standard or de-facto standard interface, with a plug-type connector that is electrically connected to a flash memory and associated flash memory controller within a housing, wherein the flash memory and associated flash memory controller are embedded within a molded package that at least partially forms a housing of the electronic plug unit;
a plug-type connector with an outer terminal that is embodied in the form of a shield and/or contact pins and that serves as a carrier and/or for making electrical contact with an integrated active electronic circuit structure that is at least partially separated from a semiconductor chip;
a plurality of semiconductor chips mounted one on the other as a second level assembly; and
a circuit structure on a film basis or fabric basis and/or on the basis of other inorganic, organic or combined materials with embedded circuit structures, printed circuit structures or with circuit structures that are applied and/or introduced using other methods, forming a level 1, and is provided with single-layer and/or multilayer redistribution lines, a redistribution layer or layers and/or further conductor tracks and surfaces for wiring at this level 1, and to which one or more additional chips, active and/or passive components, assemblies or parts thereof, forming a further level or a plurality of further levels are connected and/or placed in contact.

15. A method for fabricating an electronic plug unit, the method comprising:
providing an integrated active electronic circuit structure;
forming one or more redistribution layers on a front or a rear side of the active electronic circuit structure;
partially molding the integrated active electronic circuit structure and further active and/or passive components within a molding material;
subsequently, forming a further level of active and/or passive component(s) electrically coupled to the one or more redistribution layers; and
subsequently, performing a second molding process to form a protective layer over the further level of active and/or passive component(s).

16. The method of claim 15, further comprising planarizing the molding material after partially molding the integrated electronic circuit structure but before forming a further level of active and/or passive component(s).

17. The method of claim 15, wherein the further level of active and/or passive component(s) are formed using thin or thick film technology and are arranged under, on and/or inside the one or more redistribution layers.

18. The method of claim 15, wherein the integrated active electronic circuit structure is electrically coupled to a lead frame.

19. The method of claim 15, wherein the lead frame is electrically coupled to a plug-type connector.

20. The method of claim 19, wherein the plug-type connector is manufactured with contact pins and a shield and the lead frame as well as pads including cutouts and spring elements in the shield by punching or etching.

21. The method of claim 20, wherein the shield of the plug-type connector is provided with a section of initial material that is bent repeatedly and/or a plastic mount that is fabricated in the interior of the plug-type connector in one operation when the entire plug unit is molded.
